(19) United States
(12) Patent Application Publication
(10) Pub. No.: US 2026/0292604 A1
(43) Pub. Date: Sep. 24, 2026

(54) Multi-Access Protocol Data Unit Inter-System Change

(71) Applicant: MEDIATEK INC., Hsin-Chu (TW)

(72) Inventors: Yu-Hsin Lin, Hsinchu City (TW); Yuan-Chieh Lin, Hsinchu City (TW)

(73) Assignee: MEDIATEK INC., Hsin-Chu (TW)

(21) Appl. No.: 19/474,723

(22) PCT Filed: Jul. 17, 2024
(86) PCT No.: PCT/CN2024/105871

§ 371 Date: Oct. 13, 2025

Related U.S. Application Data
(60) Provisional application No. 63/519,290, filed on Aug. 14, 2023.

(51) Int. Cl. H04W 36/00; H04W 36/18; H04W 76/30

(52) U.S. Cl. CPC H04W 36/0022; H04W 36/185; H04W 76/30

(57) ABSTRACT

A method of inter-system change of Multi-Access (MA) Protocol Data Unit (PDU) session, performed by a user equipment (UE), includes establishing an MA PDU session with user-plane resources over a 3GPP access network in N1 mode, establishing a first Public Data Network (PDN) connection over an untrusted non-3GPP access network as a user-plane resource of the MA PDU session, transferring the MA PDU session to an Evolved Packet System (EPS) as a second PDN connection, and releasing the MA PDU session locally in response to transferring the MA PDU session to the EPS.

### CROSS REFERENCE TO RELATED APPLICATION

This application claims the benefit of U.S. Provisional Application No. 63/519,290, filed on Aug. 14, 2023. The content of the application is incorporated herein by reference.

### TECHNICAL FIELD

The present invention is related to wireless communication, and more particularly to Multi-Access PDU inter-system change.

### BACKGROUND

Access Traffic Steering, Switching and Splitting (ATSSS) is a key technology introduced in 5G networks that allows for more efficient use of available network resources. The goal of ATSSS is to optimize data traffic flow between a user equipment (UE) and the network by leveraging both cellular (3rd Generation Partnership Project or 3GPP) and Wi-Fi (non-3GPP) connections simultaneously by dynamically selecting the most suitable network path based on real-time conditions.

Key functionalities of ATSSS include traffic steering, traffic switching, and traffic splitting. ATSSS can intelligently direct different types of data traffic to the most suitable network. For example, latency-sensitive video calls might be prioritized on the cellular network, while web browsing traffic could utilize the potentially faster Wi-Fi connection. In addition, ATSSS enables seamless handover of data traffic between cellular and Wi-Fi networks when the UE moves between coverage areas, which ensures uninterrupted connectivity and avoids delays. Furthermore, ATSSS can even split a single data flow (like a large file download) and send parts over both cellular and Wi-Fi connections simultaneously, which can potentially improve overall data transfer speeds.

The current ATSSS control procedures include multi-access PDU connectivity service procedures, multi-access PDU connectivity over E-UTRAN and non-3GPP access network, and performance measurement function protocol procedures. Furthermore, multi-access PDU connectivity service procedures include management procedures for activation of multi-access PDU connectivity service, which refers to the establishment of user-plane resources on both 3GPP access and non-3GPP access.

The 3GPP specification currently allows a user equipment (UE) to establish a Packet Data Network (PDN) connection over a non-3GPP access network, which can serve as a user-plane resource for a Multi-Access (MA) Protocol Data Unit (PDU) session. In addition to this non-3GPP access network connection, the MA PDU session may also include user-plane resources established over a 3GPP access network, referred to as N1 mode. However, the current specification does not support a specific configuration of an MA PDU session with a PDN connection over E-UTRAN connected to EPC as a user-plane resource that involves a 3GPP access network in S1 mode along with a PDN connection over an untrusted non-3GPP access network as a user-plane resource. Instead, the supported combination for an MA PDN connection includes a PDN connection over 3GPP in S1 mode and the Non-3GPP Interworking Function (N3IWF).

When a mobile equipment or user equipment undergoes an inter-system change from N1 mode to S1 mode over 3GPP access, there is ambiguity regarding how the UE maintains its MA PDU session. Hence, the current specification does not provide clear guidelines on handling the MA PDU session during this transition, leaving room for interpretation and potential inconsistencies in implementation.

### SUMMARY

An embodiment provides a method of inter-system change of Multi-Access (MA) Protocol Data Unit (PDU) session performed by user equipment (UE). The method comprises establishing an MA PDU session with user-plane resources over a 3GPP access network in N1 mode, establishing a first Public Data Network (PDN) connection over an untrusted non-3GPP access network as a user-plane resource of the MA PDU session, transferring the MA PDU session to an Evolved Packet System (EPS) as a second PDN connection, and releasing the MA PDU session locally in response to transferring the MA PDU session to the EPS.

An embodiment provides a method of inter-system change of MA PDU session performed by a network entity. The method comprises receiving a request for establishing an MA PDU session for user-plane resources over a 3GPP access network in N1 mode, receiving a request for establishing a first Public Data Network (PDN) connection over an untrusted non-3GPP access network as a user-plane resource of the MA PDU session, transferring the MA PDU session to an Evolved Packet System (EPS) as a second PDN connection, and releasing the MA PDU session in response to transferring the MA PDU session to the EPS.

An embodiment provides a user equipment (UE) comprising a memory and a processor coupled to the memory. The memory is for storing program instruction and data. The processor is used to establish an MA PDU session with user-plane resources over a 3GPP access network in N1 mode, establish a first Public Data Network (PDN) connection over an untrusted non-3GPP access network as a user-plane resource of the MA PDU session, transfer the MA PDU session to an Evolved Packet System (EPS) as a second PDN connection, and release the MA PDU session locally in response to transferring the MA PDU session to the EPS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B depict access networks that supports MA PDU session management with inter-system change in accordance with the embodiments.

FIG. 2 depicts a simplified block diagram of wireless devices in accordance with the embodiments.

FIG. 3 depicts an inter-system change for an MA PDU session in accordance with the embodiments.

FIG. 4 is a flowchart of a method of inter-system change for an MA PDU session performed by a UE in accordance with the embodiments.

FIG. 5 is a flowchart of a method of inter-system change for an MA PDU session performed by a network entity in accordance with the embodiments.

FIG. 6 depicts a sequence diagram illustrating a method of inter-system change for an MA PDU session in accordance with the embodiments.

### DETAILED DESCRIPTION

### Introduction

This disclosure delves into specific details to provide a comprehensive understanding, but those skilled in the art may practice it without these specifics. Well-known methods, procedures, components, and circuits are not described in detail to maintain clarity. The disclosure primarily focuses on 3GPP wireless networks (4G and 5G), but it can be applied to other cellular and non-cellular wireless networks.

In particular, the following technique, apparatus and system can be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, the embodiment of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

As described by the 3GPP, different wireless communication systems standards and protocols can use various radio access networks (RANs) for communicating between a base station of the RAN (which may sometimes be referred to generally as a RAN node, a network node, or simply a node) and a wireless communication device known as user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN). The RAN can include base stations (cell sites), radio equipment controllers (RECs) and fronthaul and backhaul networks to transport data between base stations, RECs, and the core network.

The RAN can include one or more access nodes, which may be referred to as base station, NodeB, evolved NodeB (eNB), next Generation NodeB (gNB), 6G nodes, RAN nodes, controllers, transmission reception points (TRPs), and so forth, and can include ground stations (e.g., terrestrial access points) or satellite stations providing signal coverage within a geographic area (e.g., a cell). The RAN may include one or more RAN nodes for providing macrocells, picocells, femtocells, or other types of cells. A macrocell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having an association with the femtocell (e.g., UEs in a Closed Subscriber Group (CSG), UEs for users in the home, etc.).

A base station used by a RAN may correspond to that RAN. An example of an E-UTRAN base station is an Evolved Universal Terrestrial Radio Access Network (E-UTRAN) Node B (also referred to as evolved Node B, enhanced Node B, eNodeB, or eNB). Another example of an NG-RAN base station is a next generation Node B (also referred to as a gNodeB or gNB).

A RAN provides its communication services with external entities through its connection to a core network (CN). For example, E-UTRAN may utilize an Evolved Packet Core.

Each RAN may use one or more radio access technologies (RATs) to perform communication between the base station and the UE. For example, the GERAN implements GSM and/or EDGE RAT, the UTRAN implements UMTS RAT or other 3GPP RAT, the E-UTRAN implements LTE RAT (sometimes referred to as LTE), and NG-RAN implements NR RAT (sometimes referred to as 5G RAT, 5G NR RAT, or NR). In certain deployments, the E-UTRAN may also implement NR RAT. In certain deployments, NG-RAN may also implement LTE RAT.

The Evolved Packet Data Gateway (ePDG) is a network element within the Evolved Packet System (EPS) architecture of 4G LTE networks. Its primary responsibility is to provide secure access to the Evolved Packet Core (EPC) for untrusted non-3GPP networks, such as Wi-Fi or fixed networks. The ePDG establishes a secure tunnel using Internet Protocol Security (IPsec) between the user equipment (UE) and the EPC network, ensuring that data transmitted over untrusted networks remains encrypted and protected. This secure connection enables seamless mobility and interworking between 3GPP networks (e.g., LTE) and non-3GPP networks (e.g., Wi-Fi), allowing users to move between different access networks while maintaining a consistent connection.

In the 5G network architecture, the functionality of ePDG from 4G LTE networks is integrated into the 5G core network, specifically within the Non-3GPP Interworking Function (N3IWF). The N3IWF is a network function in 5G that takes on a similar role to the ePDG, focusing on providing secure access to the 5G core network for untrusted non-3GPP access networks. To ensure the security of data transmitted over these untrusted networks, the N3IWF establishes a secure tunnel using IPsec between the user equipment and the 5G core network, much like the ePDG does in 4G LTE.

In this specification, activating MA PDU connectivity service refers to the establishment of user-plane resources on both 3GPP access and non-3GPP access.

For terms and techniques not specifically defined or described, reference may be made to wireless communication standard documents (e.g., 3GPP Specifications) issued before this specification.

### MA PDU Session Management

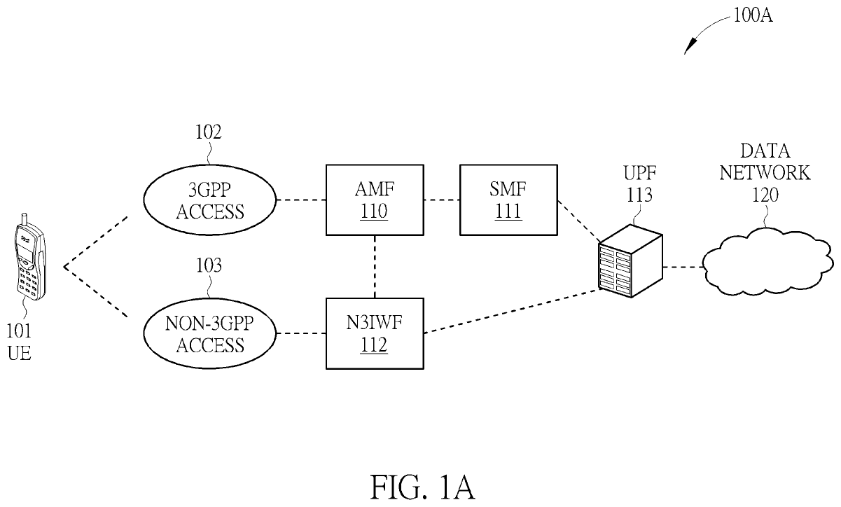

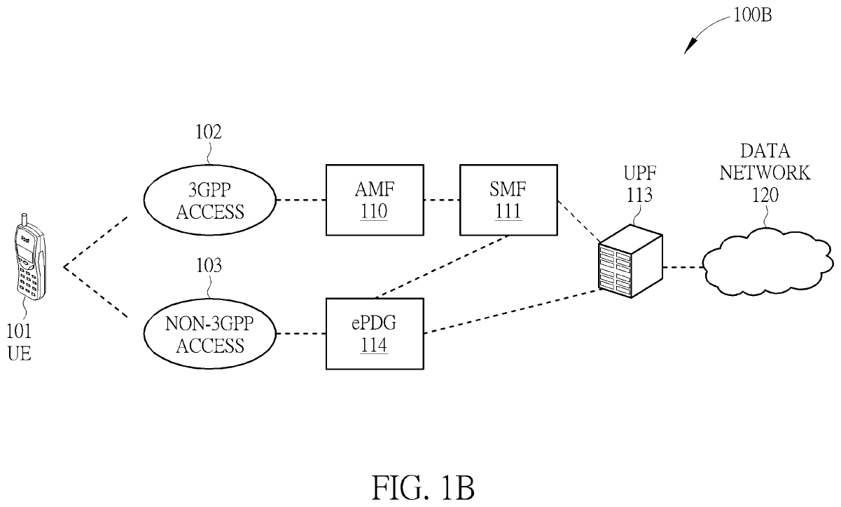

FIG. 1A depicts an access network 100A that supports Multi-Access (MA) Protocol Data Unit (PDU) session management with inter-system change in accordance with the embodiments. The access network 100A includes user equipment (UE) 101, a 3GPP access network (i.e., radio access network or RAN) 102, a non-3GPP access network 103, an Access and Mobility Management Function (AMF) 110, a Session Management Function (SMF) 111, a Non-3GPP Interworking Function (N3IWF) 112, a user-plane Function (UPF) 113, and a data network 120. The AMF interacts with the base station, SMF, and UPF for access and mobility management of wireless access devices in the mobile communication network 100A. The SMF is mainly responsible for interacting with the decoupled data plane, creating, updating, and removing PDU sessions, and managing session context with the UPF. The N3IWF functionality interfaces with 5G core network control plane functions and is responsible for routing messages outside the 5G RAN.

FIG. 1B depicts an access network 100B that supports Multi-Access (MA) Protocol Data Unit (PDU) session management with inter-system change in accordance with the embodiments. The access network 100B includes user equipment (UE) 101, a 3GPP access network (i.e., radio access network or RAN) 102, a non-3GPP access network 103, an Access and Mobility Management Function (AMF) 110, a Session Management Function (SMF) 111, an Evolved Packet Gateway (ePDG) 114, a user-plane Function (UPF) 113, and a data network 120. The AMF, SMF, and UPF functions in a similar way as in the access network 100A.

In the Access Stratum (AS) layer, RAN provides radio access for user equipment (UE) 101 via a radio access technology (RAT). In the Non-Access Stratum (NAS) layer, AMF and SMF perform access and mobility management and PDU session management of wireless access devices in the access networks 100A and 100B. The 3GPP access network (RAN) 102 may include base stations (gNBs or eNBs) providing radio access for UE 101 via various 3GPP RATs, including 5G, 4G, and 3G/2G. The non-3GPP access network 103 may include access points (APs) providing radio access for UE 101 via non-3GPP RAT, such as Wi-Fi.

The UE 101, (i.e., a device used by an end-user to communicate) has two main paths to connect to the data network 120. The first path is through the 3GPP access network 102. In this path, the UE 101 connects to the 3GPP access network 102, and then its data and signaling is routed through several network functions, including the Access and Mobility Management Function (AMF) 110, Session Management Function (SMF) 111, and user-plane Function (UPF) 113, before finally reaching the data network 120.

The second path for the UE 101 to access the data network 120 is through the non-3GPP access network 103, which could be a Wi-Fi network or other type of non-cellular network. In this case, the UE 101 first connects to the non-3GPP access network 103, and then its data is routed through either the N3IWF 112 (in the access networks 100A) or the ePDG 114 (in the access networks 100B), depending on the specific type of non-3GPP access network. After passing through one of these components, the data goes through UPF 113 before reaching the data network 120.

In addition, the UE 101 may be equipped with a single radio frequency (RF) module or transceiver or multiple RF modules or transceivers for services via different RATs and/or CNs.

5GS networks are packet-switched (PS) Internet Protocol (IP) networks that deliver all data traffic in IP packets and provide users with Always-On IP Connectivity. When UE joins an EPS network, a Packet Data Network (PDN) address (i.e., the one that can be used on the PDN) is assigned to the UE for its connection to the PDN. In 4G, EPS has defined a Default EPS Bearer to provide the IP Connectivity that is Always-On. In 5G, a PDU session establishment procedure is a parallel procedure to a PDN connection procedure in 4G. A PDU session defines the association between the UE and the data network that provides a PDU connectivity service. Each PDU session is identified by a PDU session ID and may include multiple Quality-of-Service (QoS) flows and QoS rules. In 5G networks, QoS flow is the fine granularity for QoS management to enable more flexible QoS control, similar to the concept of EPS bearer in 4G.

Each PDU session can be established over a 3GPP network or a non-3GPP network for radio access. 5G Session management (5GSM) for PDU sessions over both 3GPP access and non-3GPP access are managed by AMF and SMF via NAS signaling. Operators are seeking ways to balance data traffic between mobile networks and non-3GPP access in a way that is transparent to users and reduces mobile network congestion. In 5GS, UEs can be simultaneously connected to both 3GPP access and non-3GPP access (using 3GPP NAS signaling), allowing the 5GS to take advantage of these multiple accesses to improve user experience and optimize traffic distribution across various accesses. Accordingly, 3GPP introduced MA PDU sessions in 5GS, which uses one 3GPP access network or one non-3GPP access network at a time, or simultaneously one 3GPP access network and one non-3GPP access network. Additionally, the UE and the network can support Access Traffic Steering Switching and Splitting (ATSSS) functionalities to distribute traffic over 3GPP access and non-3GPP access for the established MA PDU session.

When an MA PDU session is established in 5GS, it includes a number of QoS flows in the Non-Access Stratum (NAS) layer. Each QoS flow may be mapped to a corresponding EPS bearer. Based on ATSSS rules, an application/service may use a QoS flow via 3GPP access or non-3GPP access. When a QoS flow is added, the network can provide a QoS flow description information element (IE) to the UE, which comprises a list of QoS flow descriptions. Each QoS flow description comprises a QoS flow identifier (QFI), a QoS flow operation code, a number of QoS flow parameters, and a QoS flow parameters list. Each parameter included in the parameters list comprises a parameter identifier that identifies the corresponding parameter. One of the parameter identifiers is the EPS bearer identity (EBI), which is used to identify the EPS bearer that is mapped to or associated with the QoS flow. However, if an MA PDU session does not support interworking with EPS, then there are no associated ESM parameters, e.g., EBI or mapped EPS bearer contexts, when inter-system change occurs from 5GS to EPS over 3GPP access.

However, according to the current specifications, an MA PDU session that simultaneously includes 3GPP access in S1 mode (connected to the 4G/LTE network) and a PDN connection over untrusted non-3GPP access (e.g., Wi-Fi) as a user-plane resources over the MA PDU session (as shown in FIG. 1B) is not supported. In other words, the existing standards do not define a mechanism for an MA PDU session to have both “3GPP access in S1 mode” and “ user-plane resource with the PDN connection over untrusted non-3GPP access network” concurrently. The present disclosure introduces and describes the procedures for supporting an MA PDU session that includes both 3GPP access in S1 mode (connected to the 4G/LTE network) and a PDN connection over untrusted non-3GPP access (e.g., Wi-Fi) as a user-plane resources over the MA PDU session simultaneously. In other words, this disclosure presents the mechanisms and steps required to enable an MA PDU session to concurrently maintain “3GPP access in S1 mode” and “user-plane resource with the PDN connection over untrusted non-3GPP access network”, a scenario which was previously not defined in the existing 3GPP standards.

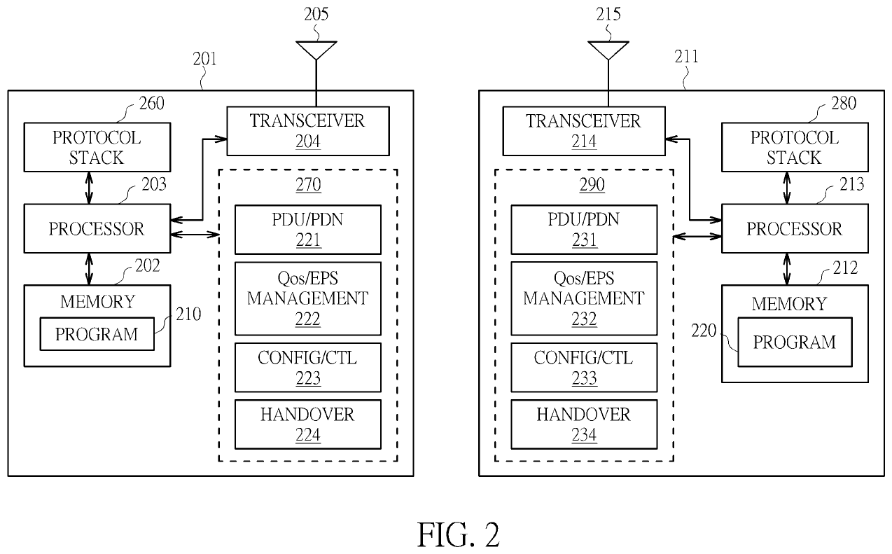

FIG. 2 depicts a simplified block diagram of wireless devices (i.e., a UE 201 and a network entity 211) in accordance with the embodiments. The network entity 211, which may be a base station and/or an AMF/SMF, is equipped with several key components described as follows. An antenna 215 transmits and receives radio signals, while a radio frequency (RF) transceiver 214, coupled to the antenna, receives RF signals from antenna 215, converts them to baseband signals, and forwards them to processor 213. The RF transceiver 214 also converts baseband signals received from processor 213 into RF signals and sends them out via antenna 215. The processor 213 processes the received baseband signals and invokes various functional modules to execute features in network entity 211, and a memory 212 stores program instructions and data 220 to control the operations of the network entity 211.

The network entity 211 further includes a protocol stack 280 and a set of control functional modules and circuits 290 with several key components describe as follows. A PDU session and PDN connection handling circuit 231 manages PDU/PDN establishment and modification procedures, while a QoS and EPS bearer management circuit 232 creates, modifies, and deletes QoS and EPS bearers for UE. A configuration and control circuit 233 provides different parameters to configure and control UE-related functionalities, such as mobility management and PDU session management. A handover module 234 handles handover and inter-system change functionalities between 5GS and EPS.

Similarly, the UE 201 includes a memory 202, a processor 203, and a radio frequency (RF) transceiver 204. The RF transceiver 204, coupled to the antenna 205, receives RF signals from antenna 205, converts them to baseband signals, and sends them to the processor 203. The RF transceiver 204 also converts baseband signals received from the processor 203 into RF signals and transmits them via the antenna 205. The processor 203 processes the received baseband signals and invokes different functional modules and circuits to perform features in the UE 201. The memory 202 stores data and program instructions 210 to be executed by the processor 203 to control the operations of UE 201. The processor 203 may be implemented with, for example, a special purpose processor, a digital signal processor (DSP), multiple micro-processors, one or more micro-processors combined with a DSP core, a controller, a microcontroller, application specific integrated circuits (ASICs), field programmable gate arrays (FPGAs), other types of integrated circuits (ICs), and/or state machines. The processor 203 with software can be used to implement and configure features of UE 201.

The UE 201 is also equipped with a set of functional modules and control circuits that enable it to perform its tasks, including protocol stacks 260 comprising Non-Access-Stratum (NAS) layer for communicating with core network entities (AMF/SMF/MME), Radio Resource Control (RRC) layer for high-level configuration and control, Packet Data Convergence Protocol/Radio Link Control (PDCP/RLC) layer, Media Access Control (MAC) layer, and Physical (PHY) layer, as well as system modules and circuits 270 that can be implemented using software, firmware, hardware, or a combination thereof, and when executed by the processors using program instructions stored in memory, interwork with each other to enable UE 201 to perform embodiments, functional tasks, and features within the network.

The system modules and circuits 270 comprise several key components that collaboratively manage PDU sessions, PDN connections, QoS flows, EPS bearers, and handle mobility. The PDU session and PDN connection handling circuit 221 executes procedures to establish and modify PDU sessions in 5G and PDN connections in 4G, while the QoS flow and EPS bearer handling circuit 222 manages the lifecycle of QoS flows in 5G and their mapped EPS bearer contexts in 4G. The configuration and control circuit 223 handles various configuration and control parameters related to mobility management and session management functions, and the handover module 224 manages handover and inter-system change procedures to ensure seamless transition of PDU sessions and QoS flows when the device moves between 5G and 4G coverage, enabling efficient management of multi-access connectivity, QoS, and mobility between 5G and 4G networks.

### MA PDU Inter-System Change

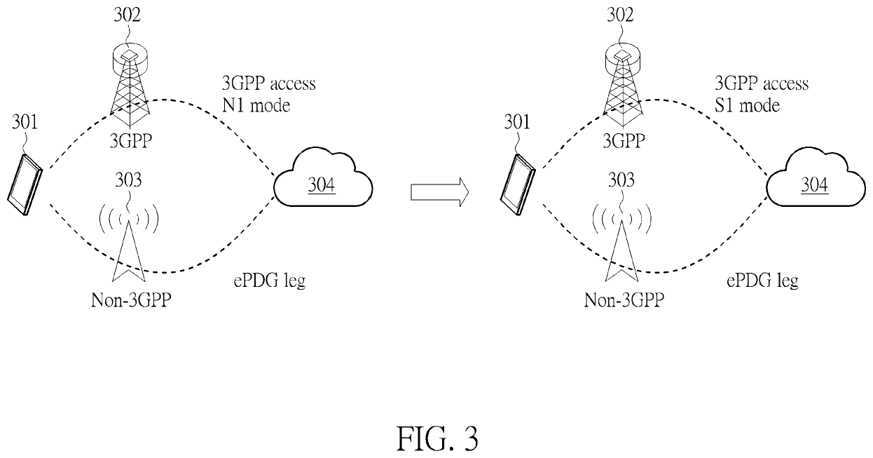

FIG. 3 depicts an inter-system change for an MA PDU session in accordance with the embodiments. Initially, the UE 301 is connected to a data network 304 simultaneously through a 3GPP access network 302 in N1 mode (5G) and an untrusted non-3GPP access network 303. Following the inter-system change, the UE 301 maintains its connectivity to the data network 304 via both the 3GPP access network 302, now in S1 mode (4G/LTE), and the untrusted non-3GPP access network 303. The procedures are described as follows.

If the UE (e.g., UE 301) established an MA PDU session with the user-plane resource over 3GPP access network (e.g., network 302) and the user-plane resource with the PDN connection over untrusted non-3GPP access network (e.g., network 303), the UE can follow the procedure specified in 3GPP TS 24.501.

When interworking between 5G System (5GS) and EPS is supported, it can maintain an MA PDU session in 5GS over both 3GPP and non-3GPP access. In other words, the UE has successfully established user-plane resources for the MA PDU session on both access types. In this scenario, if the UE undergoes an inter-system change from 5GS to EPS over 3GPP access, the system will handle the transition in a specific manner.

During the inter-system change, the 3GPP part of the PDU session will be transferred to the corresponding PDN connection in EPS. This ensures that the data traffic previously handled by the 3GPP access in 5GS is now managed by the EPS network. Meanwhile, the non-3GPP part of the PDU session will be released, as it is no longer needed in the EPS environment. Additionally, the QoS flows associated with the MA PDU session over both 3GPP and non-3GPP access will be transferred to the EPS bearer contexts of the corresponding PDN connection. This ensures that the QoS requirements are maintained during the transition.

On the other hand, if the interworking between 5GS and EPS is not supported for a PDU session, the process is handled differently. In this case, when the UE undergoes an inter-system change from 5GS to EPS over 3GPP access, the MA PDU session is maintained in 5GS over non-3GPP access and not transferred to EPS. The session remains active on the non-3GPP access, ensuring continuity of the data connection. As a result, the data traffic that was previously handled by the MA PDU session over 3GPP access is now moved to the non-3GPP access and the network may modify the tunnel and update ATSSS rules accordingly. This allows the device to continue its data communication seamlessly, even though the 3GPP access is no longer available in the EPS network.

After inter-system change from N1 (5GS) mode to S1 (4G, EPS) mode, if interworking with EPS is supported for a PDU session, the PDU session in 5GS is transferred to a corresponding PDN connection in EPS, and QoS flows of the PDU session are mapped to associated EPS bearers. However, UE behavior is undefined on how to handle an MA PDU session when inter-system changes from 5GS to EPS, regardless of whether interworking with EPS for a PDU session is supported or not.

In a network supporting the N26 interface, if the UE has established an MA PDU session over both 3GPP access and non-3GPP access, the UE follows the procedure specified in clause 6.1.4.1 of 3GPP TS 24.501. When the UE performs an inter-system change from N1 mode to S1 mode, there are three possible scenarios:
a) If the MA PDU session is transferred to EPS as a PDN connection and the UE did not indicate support for establishing a PDN connection as the user-plane resource of an MA PDU session during the MA PDU session establishment procedure, the SMF can initiate the network-requested PDU session release procedure over non-3GPP access or perform a local release of the MA PDU session. The UE performs a local release of the MA PDU session over both 3GPP access and non-3GPP access.
b) If the MA PDU session is transferred to EPS as a PDN connection and the UE indicated support for establishing a PDN connection as the user-plane resource of an MA PDU session during the MA PDU session establishment procedure, the SMF can keep the MA PDU session over non-3GPP access.
c) If the MA PDU session is not transferred to EPS as a PDN connection and the SMF decides to move the traffic of the MA PDU session from 3GPP access to non-3GPP access, the SMF can initiate the network-requested PDU session modification procedure.

When the UE transitions from N1 mode to SI mode, it creates the default and dedicated EPS bearer contexts using the parameters of the mapped EPS bearer contexts or the associations between QoS flows and mapped EPS bearers in the PDU session, if available. The EPS bearer identity assigned to the QoS flow of the default QoS rule becomes the default bearer's EPS bearer identity in the corresponding PDN connection.

If there is no EPS bearer identity assigned to the QoS flow of the default QoS rule of a PDU session associated with 3GPP access, or if there are no corresponding mapped EPS bearer contexts associated with the EPS bearer identity assigned to the QoS flow of the default QoS rule of a PDU session associated with 3GPP access, the UE would take the following actions: a) If the PDU session is not an MA PDU session established over both 3GPP and non-3GPP access, the UE performs a local release of the PDU session; b) If the PDU session is an MA PDU session established over both 3GPP and non-3GPP access, the UE performs a local release of the PDU session over 3GPP access and consider the MA PDU session to be established over non- 3GPP access only.

In cases where there is no EPS bearer identity assigned to the QoS flow of a PDU session associated with 3GPP access which is not associated with the default QoS rule, or if there are no corresponding mapped EPS bearer contexts associated with the EPS bearer identity assigned to the QoS flow of the non-default QoS rule of a PDU session associated with 3GPP access, the UE would locally delete the QoS rules and the QoS flow description, unless the PDU session is an MA PDU session established over both 3GPP and non-3GPP access.

The UE uses the parameters from each PDU session for which interworking with EPS is supported to create the corresponding default EPS bearer context and, optionally, dedicated EPS bearer context.

Furthermore, when the MA PDU session is transferred to EPS as a PDN connection, there are two possible scenarios:
a) If the UE did not indicate support for establishing a PDN connection as the user-plane resource of an MA PDU session during the MA PDU session establishment procedure, the SMF can either initiate the tunnel disconnection procedure over untrusted non-3GPP access network or perform a local release of the MA PDU session. In this case, the UE performs a local release of the MA PDU session over both 3GPP access and untrusted non-3GPP access.
b) If the UE indicates support for establishing a PDN connection as the user-plane resource of an MA PDU session during the MA PDU session establishment procedure, the network can maintain the MA PDU session with the user-plane resource associated with the PDN connection over 3GPP access network and locally release the user-plane resource over untrusted non-3GPP access. In this case, the UE performs a local release of the MA PDU session over untrusted non-3GPP access.

In a network not supporting the N26 interface, when the UE intends to transfer the MA PDU session to EPS during an inter-system change from N1 mode to S1 mode, and the UE did not indicate support for establishing a PDN connection as the user-plane resource of an MA PDU session during the MA PDU session establishment procedure, the UE follows the procedure as specified in clause 6.1.4.2 of 3GPP TS 24.501 and performs a local release of the MA PDU session over both 3GPP access and non-3GPP access. The SMF can initiate the network-requested PDU session release procedure over non-3GPP access or perform a local release of the MA PDU session. When the network does not support N26 interface, the SMF does not provide the UE with the mapped EPS bearer context for a PDU session.

In the same scenario as above, the SMF can also initiate the tunnel disconnection procedure over untrusted non-3GPP access network or perform a local release of the MA PDU session.

When the UE intends to transfer the MA PDU session to EPS during an inter-system change from N1 mode to S1 mode, and the UE indicated support for establishing a PDN connection as the user-plane resource of an MA PDU session during the MA PDU session establishment procedure, the UE follows the procedure in clause 6.1.4.2 of 3GPP TS 24.501 and performs a local release of the MA PDU session over 3GPP access. The SMF can keep the MA PDU session over non-3GPP access.

In the same scenario as above, the SMF can also locally release the user-plane resource over untrusted non-3GPP access, and the UE performs a local release of the MA PDU session over untrusted non-3GPP access.

In essence, MA PDU session and PDN connection establishment can be outlined as follows:
a) If the UE does not support establishing a PDN connection as the user-plane resource of an MA PDU session, or if the network does not support this capability, the MA PDU session is released.
b) The UE transfers the MA PDU session to EPS as a PDN connection in S1 mode over the 4G access network.

MA PDU session interworking with N26 interface:
a) If the network supports the N26 interface between the 5G and 4G core networks, and if the UE supports establishing a PDN connection as the user-plane resource of an MA PDU session, the UE will create corresponding default EPS bearer context and dedicated EPS bearer context of the PDN connection of the MA PDU session.
b) The SMF can keep the MA PDU session with the user-plane resource with the PDN connection over 3GPP access network and locally release the user-plane resource over untrusted non-3GPP access initiates an MA PDU session modification procedure to remove the user-plane resources over the non-3GPP access untrusted non-3GPP access.
c) The new PDN connection in S1 mode is associated with the existing MA PDU session and serves as the user-plane resource for the MA PDU session over the 4G access network.

MA PDU session interworking without N26 interface:
a) If the network does not support the N26 interface, the UE would initiate a PDN Connection Establishment procedure in S1 mode to transfer the PDU session to a new PDN connection over the 4G access network.
b) The new PDN connection in S1 mode is associated with the existing MA PDU session and serves as the user-plane resource for the MA PDU session over the 4G access network.

It should be noted that the N26 interface is a reference point between the MME in the 4G/LTE EPC and the 5G Core network. It enables seamless handovers and backward compatibility interworking between the 5G and 4G networks. The N26 interface facilitates the exchange of mobility management and session management states between the MME and 5GC, ensuring continuity of data sessions during inter-system changes. It also supports the transfer of PDN connections between 4G and 5G networks, the exchange of security context information secure communication during handovers, and the delivery of SMS messages over the 5G core network. The presence of the N26 interface in a network deployment enables tighter integration and interworking between 4G and 5G networks.

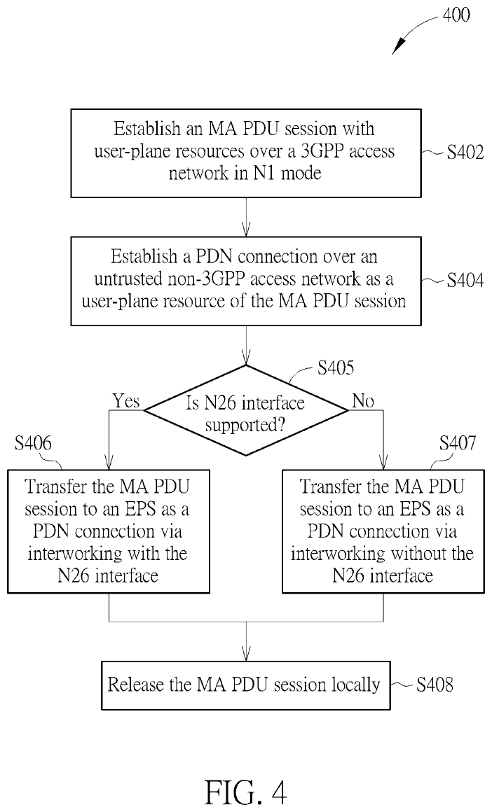

FIG. 4 is a flowchart of an exemplary method 400 of inter-system change for an MA PDU session, performed by a UE (e.g., UE 201). The method 400 includes the following key steps:
S402: Establish an MA PDU session with user-plane resources over a 3GPP access network in N1 mode;
S404: Establish a PDN connection over an untrusted non-3GPP access network as a user-plane resource of the MA PDU session;
S405: Is N26 interface supported? If so, proceed to step S406; if not, proceed to step S407;
S406: Transfer the MA PDU session to an EPS as a PDN connection via interworking with the N26 interface; proceed to step S408;
S407: Transfer the MA PDU session to an EPS as a PDN connection via interworking without the N26 interface; and
S408: Release the MA PDU session locally.

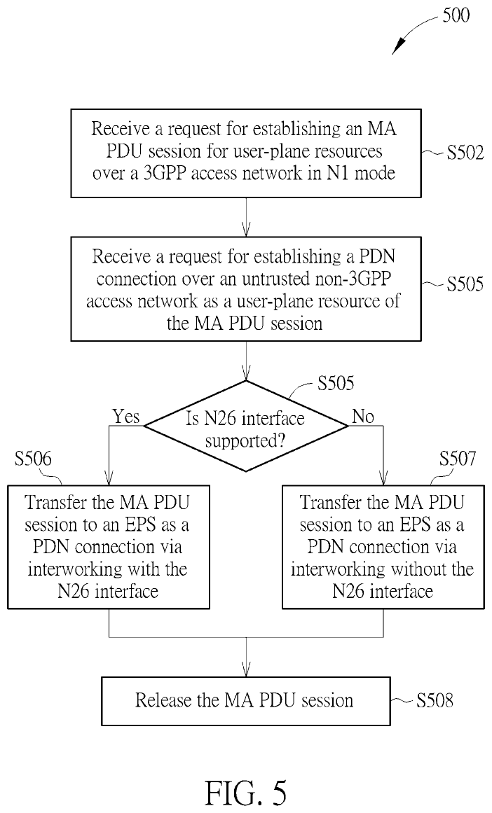

FIG. 5 is a flowchart of an exemplary method 500 of inter-system change for an MA PDU session, performed by a network entity (e.g., network entity 211). The method 500 includes the following key steps:
S502: Receive a request for establishing an MA PDU session for user-plane resources over a 3GPP access network in N1 mode;
S504: Receive a request for establishing a PDN connection over an untrusted non-3GPP access network as a user-plane resource of the MA PDU session;
S505: Is N26 interface supported? If so, proceed to step S506; if not, proceed to step S507;
S506: Transfer the MA PDU session to an EPS as a PDN connection via interworking with the N26 interface; proceed to step S508;
S507: Transfer the MA PDU session to an EPS as a PDN connection via interworking without the N26 interface; and
S508: Release the MA PDU session.

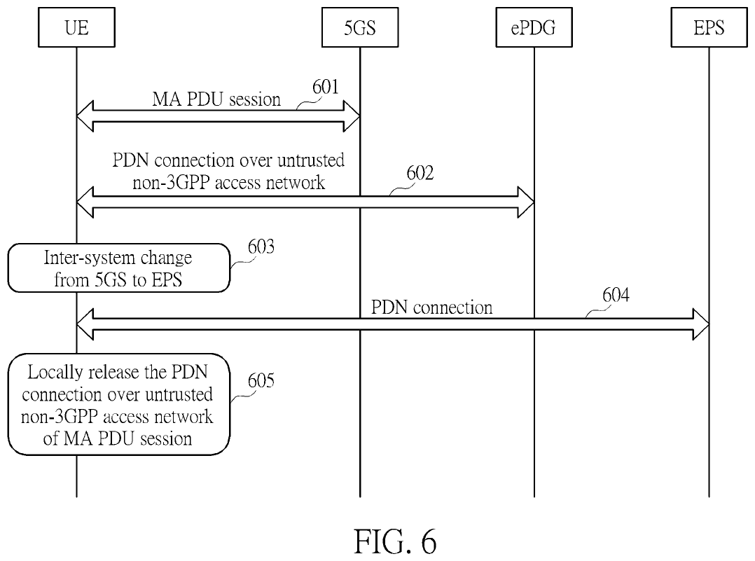

FIG. 6 depicts a sequence diagram illustrating a method 600 of inter-system change for an MA PDU session in accordance with the embodiments. In step 601, an MA PDU session is established between UE (e.g., UE 211) and the 5GS. The MA PDU session comprises a PSI and other 5GSM parameters including S-NSSAI, session-AMBR and one or more QoS flow descriptions. In step 602, a PDN connection over untrusted non-3GPP access network as a user-plane resource of the MA PDU session is established between the UE and the ePDG. In step 603, the UE performs inter-system change from 5GS to EPS. A PDN connection is created based on the mapped information of the MD PDU session. As a result, in step 604, the PDN connection is established between the UE and the EPS. Finally, in step 605, the UE locally releases the PDN connection over untrusted non-3GPP access network of MA PDU session.

It is important to note that, in step 601, the UE provides Request Type as “MA PDU Request” in UL NAS Transport message and its ATSSS Capabilities as defined in clause 5.32.2 of TS 23.501 in PDU Session Establishment Request message. Also, the UE receives a PDU Session Establishment Accept message, which indicates to UE that the requested MA PDU session was successfully established. This message includes the ATSSS rules for the MA PDU session.

It should also be noted that, in step 602, the UE sends ATSSS container with the ATSSS request PCO parameter in the IKE_AUTH request message to the ePDG including the IP address of the MA PDU Session in CFG_REQUEST Configuration Payload, an “MA PDU Request” indication and the PDU Session ID of the existing MA PDU Session on non-3GPP access over 5GC.

More specifics about this process are detailed in the 3GPP technical specification document TS 24.501, “Non-Access-Stratum (NAS) protocol for 5G System (5GS)” and TS 24.193, “Access Traffic Steering, Switching and Splitting (ATSSS).” These documents, published by the 3GPP, provide an in-depth description of the steps and message flows that supplement the above-mentioned procedures.

### Additional Notes

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain voice or non-voice data/control information, regardless of whether these signals are analog or digital in nature.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IoT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in this specification, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN. Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

In some embodiments, the computing instructions may be executed by an operating system, which may include but is not limited to Microsoft Windows, Apple Mac OS X, macOS or iOS, various distributions of the Linux operating system, or Google Android operating system.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of inter-system change of a Multi-Access (MA) Protocol Data Unit (PDU) session, performed by user equipment (UE), comprising:
establishing an MA PDU session with user-plane resources over a 3GPP access network in N1 mode;
establishing a first Public Data Network (PDN) connection over an untrusted non-3GPP access network as a user-plane resource of the MA PDU session;
transferring the MA PDU session to an Evolved Packet System (EPS) as a second PDN connection; and
releasing the MA PDU session locally in response to transferring the MA PDU session to the EPS.

2. The method of claim 1, wherein transferring the MA PDU session to the EPS as the second PDN connection comprises transferring the MA PDU session via interworking with an N26 interface.

3. The method of claim 2, further comprising creating default EPS bearer context and dedicated EPS bearer context based on EPS bearer context of the MA PDU session.

4. The method of claim 1, wherein transferring the MA PDU session to the EPS as the second PDN connection comprises transferring the MA PDU session to the EPS as the second PDN connection via interworking without an N26 interface.

5. The method of claim 4, wherein transferring the MA PDU session to the EPS as the second PDN connection via interworking without the N26 interface comprises transferring the MA PDU session using Session Management (SM) protocol.

6. The method of claim 1, wherein releasing the MA PDU session locally is releasing the MA PDU session locally over the untrusted non-3GPP access network if the UE indicates supporting of establishing a PDN connection as the user-plane resource of the MA PDU session.

7. The method of claim 1, wherein releasing the MA PDU session locally in response to transferring the MA PDU session to the EPS is releasing the MA PDU session locally over the 3GPP access network and/or the untrusted non-3GPP access network if the UE does not indicate supporting of establishing a PDN connection as a user-plane resource of the MA PDU session.

8. A method of inter-system change of Multi-Access (MA) Protocol Data Unit (PDU) session, performed by a network entity, comprising:
receiving a request for establishing an MA PDU session for user-plane resources over a 3GPP access network in N1 mode;
receiving a request for establishing a first Public Data Network (PDN) connection over an untrusted non-3GPP access network as a user-plane resource of the MA PDU session;
transferring the MA PDU session to an Evolved Packet System (EPS) as a second PDN connection; and
releasing the MA PDU session in response to transferring the MA PDU session to the EPS.

9. The method of claim 8, wherein transferring the MA PDU session to the EPS as the second PDN connection comprises transferring the MA PDU session via interworking with an N26 interface.

10. The method of claim 9, further comprising creating default EPS bearer context and dedicated EPS bearer context based on EPS bearer context in the MA PDU session.

11. The method of claim 8, wherein transferring the MA PDU session to the EPS as the second PDN connection comprises transferring the MA PDU session to the EPS as the second PDN connection via interworking without an N26 interface.

12. The method of claim 11, wherein transferring the MA PDU session to the EPS as the second PDN connection via interworking without the N26 interface comprises transferring the MA PDU session using Session Management (SM) protocol.

13. The method of claim 8, wherein releasing the MA PDU session in response to transferring the MA PDU session to the EPS is releasing the MA PDU session over the untrusted non-3GPP access network if the UE indicates supporting of establishing a PDN connection as a user-plane resource of the MA PDU session.

14. The method of claim 8, wherein releasing the MA PDU session in response to transferring the MA PDU session to the EPS is releasing the MA PDU session over the 3GPP access network and/or the untrusted non-3GPP access network if the UE does not indicate supporting of establishing a PDN connection as a user-plane resource of the MA PDU session.

15. The method of claim 8, wherein releasing the MA PDU session comprises:
locally releasing the MA PDU session; or
initiating a tunnel disconnection procedure over the untrusted non-3GPP access network.

16. A user equipment (UE) comprising:
a memory for storing program instruction and data; and
a processor coupled to the memory, configured to:
establish an MA PDU session with user-plane resources over a 3GPP access network in N1 mode;
establish a first Public Data Network (PDN) connection over an untrusted non-3GPP access network as a user-plane resource of the MA PDU session;
transfer the MA PDU session to an Evolved Packet System (EPS) as a second PDN connection; and
release the MA PDU session locally in response to transferring the MA PDU session to the EPS.

17. The user equipment of claim 16, wherein the processor is further configured to map the MA PDU session to the second PDN connection.

18. The user equipment of claim 17, wherein the processor is further configured to create default EPS bearer context and dedicated EPS bearer context based on EPS bearer context in the MA PDU session.

19. The user equipment of claim 16, wherein the processor is further configured to transfer the MA PDU session to the EPS as the second PDN connection via interworking with an N26 interface if the N26 interface is supported.

20. The user equipment of claim 19, wherein the processor is further configured to transfer the MA PDU session using Session Management (SM) protocol.

21. The user equipment of claim 16, wherein the processor is further configured to release the MA PDU session locally over the untrusted non-3GPP access network in response to transferring the MA PDU session to the EPS if the UE indicates supporting of establishing a PDN connection as a user-plane resource of the MA PDU session.

22. The user equipment of claim 16, wherein the processor is further configured to release the MA PDU session locally over the 3GPP access network and/or the untrusted non-3GPP access network in response to transferring the MA PDU session to the EPS if the UE does not indicate supporting of establishing a PDN connection as a user-plane resource of the MA PDU session.
